(19) United States
(12) Patent Application Publication
(10) Pub. No.: US 2012/0141065 A1
(43) Pub. Date: Jun. 7, 2012

(54) OPTICAL WAVEGUIDE COLLIMATOR AND OPTICAL SWITCHING DEVICE

(75) Inventors: Atsushi OGURI, Tokyo (JP); Hiroshi Matsuura, Tokyo (JP); Katsuki Suematsu, Tokyo (JP); Nobuhiro Nanri, Tokyo (JP)

(73) Assignee: FURUKAWA ELECTRIC CO., LTD., Tokyo (JP)

(21) Appl. No.: 13/397,764

(22) Filed: Feb. 16, 2012

Related U.S. Application Data
(63) Continuation of application No. PCT/JP11/55704, filed on Mar. 10, 2011.

(30) Foreign Application Priority Data
Oct. 6, 2010 (JP) 2010-226468

(51) Int. Cl. G02B 6/32; G02B 6/26

(52) U.S. Cl. 385/16; 385/33

(57) ABSTRACT

An optical waveguide collimator includes: an optical waveguide base material which includes a light emitting face having a light emitting end face of an optical waveguide, and an adhering area face provided separated from the light emitting face; a collimator lens arranged on a light emitting end face side of the optical waveguide; and a lens holding member which holds the collimator lens and which is adhered and fixed to the adhering area face of the optical waveguide base material.

### CROSS-REFERENCE TO RELATED APPLICATIONS

This application is a continuation of PCT International Application No. PCT/JP2011/055704 filed on Mar. 10, 2011 which claims the benefit of priority from Japanese Patent Application No. 2010-226468 filed on Oct. 6, 2010, the entire contents of which are incorporated herein by reference.

### BACKGROUND OF THE INVENTION

1. Field of the Invention

The present invention relates to an optical waveguide collimator in which collimator lenses are arranged on a light emitting end face side of optical waveguides such as optical fibers and to an optical switching device having the optical waveguide collimator.

2. Description of the Related Art

Light emitted from optical waveguides such as optical fibers propagates through space while widening their beam diameters depending on numerical apertures of the optical fibers. Hence, especially in a space coupling system, collimator lenses are arranged on a light emitting end face side of optical fibers to collimate or condense the emitted light so that the emitted light are handled easily.

When collimator lenses are arranged on the light emitting end side of the optical fibers, an optimal interval distance between the light emitting end faces of the optical fibers and the collimator lenses (for example, 0.1 to several millimeters) should be set according to the numerical apertures of the optical fibers and focusing lengths of the collimator lenses. In order to achieve the interval distance, there is a method of arranging a spacer formed with a glass plate between the optical fibers and the collimator lenses as a member for holding the collimator lenses (see, for example, Japanese Patent Application Laid-open No. 2008-40447).

Unfortunately, in such a conventional configuration, the member for holding the collimator lenses is readily detached.

It is therefore an object of the present invention to provide an optical waveguide collimator which prevents a member for holding collimator lenses from being detached and an optical switching device having the optical waveguide collimator.

### SUMMARY OF THE INVENTION

According to one aspect of the present invention, there is provided an optical waveguide collimator including: an optical waveguide base material which includes a light emitting face having a light emitting end face of an optical waveguide, and an adhering area face provided separated from the light emitting face; a collimator lens arranged on a light emitting end face side of the optical waveguide; and a lens holding member which holds the collimator lens and which is adhered and fixed to the adhering area face of the optical waveguide base material.

According to another aspect of the present invention, there is provided an optical switching device including the optical waveguide collimator

The above and other features, advantages, and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic perspective view of an optical fiber collimator according to a first embodiment of the present invention.

FIG. 2 is an exploded perspective view of an optical fiber collimator according to the first embodiment.

FIG. 3 is an enlarged perspective view of a portion to which collimator lenses in an optical fiber collimator according to the first embodiment are attached.

FIG. 4 is a sectional view of IV-IV in FIG. 1.

FIG. 5 is an enlarged sectional view of a portion to which collimator lenses in an optical fiber collimator according to the first embodiment are attached.

FIG. 6 is a schematic perspective view of an optical fiber collimator according to a second embodiment of the present invention.

FIG. 7 is an A arrow view of an optical fiber fixing base material of an optical fiber collimator illustrated in FIG. 6.

FIG. 8 is a partial sectional view of an optical fiber collimator illustrated in FIG. 6 along an optical fiber.

FIG. 9 is a schematic perspective view illustrating an optical fiber collimator according to a modified example of the second embodiment.

FIG. 10 is a schematic perspective view of an optical fiber collimator according to a third embodiment of the present invention.

FIG. 11 is a schematic perspective view of an optical fiber collimator according to a fourth embodiment of the present invention.

FIG. 12 is a schematic perspective view of an optical fiber collimator according to a fifth embodiment of the present invention.

FIG. 13 is a schematic perspective view of an optical fiber collimator according to a sixth embodiment of the present invention.

FIG. 14 is a block diagram illustrating a configuration of an optical switching device according to a seventh embodiment of the present invention.

FIG. 15 is an explanatory diagram of an operation of an optical switching device illustrated in FIG. 14.

FIG. 16 is a schematic perspective view of a conventional optical fiber collimator.

### DETAILED DESCRIPTION OF THE PREFERRED EMBODIMENTS

Exemplary embodiments of an optical waveguide collimator and an optical switching device according to the present invention will be described in detail with reference to the drawings. The present invention is not limited to these embodiments. The same reference numerals are used to designate the same or corresponding elements in the drawings. Further, it should be noted that the drawings are schematic, and the relationship between the thickness and width of each layer and the ratio of each layer are different from actual ones. There may be difference of dimensions and difference of ratios between the drawings.

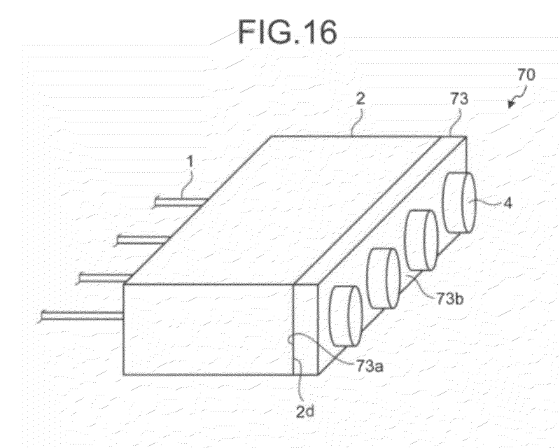

FIG. 16 is a schematic perspective view of a conventional optical fiber collimator 70. The optical fiber collimator 70 has an optical fiber fixing base material 2 which allows insertion of optical fibers 1 aligned in an array pattern and fixes the optical fibers 1, a spacer 73 which is formed with a glass plate and has a primary face 73a bonded to a light emitting face 2d of the optical fiber fixing base material 2, and collimator lenses 4 bonded to the other primary face 73b of the spacer 73.

The optical fiber collimator 70 secures an optimal interval distance between the collimator lenses 4 and light emitting end faces of optical fibers 1 due to the thickness of the spacer 73.

When the spacer 73 is bonded to the light emitting face 2d of the optical fiber fixing base material 2 and when the collimator lenses 4 are bonded to the spacer 73, using adhesive is simple, reduces cost and enables miniaturization. In general, AR (Anti-Reflection) coating which is an anti-reflection film is formed on light emitting end faces of the optical fibers 1 to prevent reflection on the end faces. To form the AR coating on the light emitting end faces of the optical fibers 1, it is simple to form the AR coating on the light emitting end faces of the optical fibers 1 and the entire light emitting face 2d of the optical fiber fixing base material 2. The light emitting face 2d is coplanar with the light emitting end faces. Further, the AR coating is preferably formed on the primary face 73a which is a bonding face between the optical fiber fixing base material 2 and the spacer 73, and on the primary face 73b which is a bonding face between the collimator lenses 4 and the spacer 73.

However, in the conventional optical fiber collimator 70 illustrated in FIG. 16, the spacer 73 may be detached from the optical fiber fixing base material 2 because external force or inner stress resulting from thermal expansion or contraction places a load on the spacer 73. The AR coating is formed by layering multiple dielectric films, and is easily peeled off particularly. Hence, when the AR coating is peeled off from the light emitting face 2d of the optical fiber fixing base material 2 or the surface of the primary face 73a of the spacer 73, the spacer 73 is readily detached from the optical fiber fixing base material 2. In this case, the light emitting face 2d to which the spacer 73 is adhered and the light emitting end faces of the optical fibers 1 (the light emitting end faces are coplanar with the light emitting face 2d) may be damaged due to impact by detachment through the adhesive. Particularly when the AR coating is formed on the entire light emitting end faces of the optical fibers 1 and the light emitting face 2d, detachment of the spacer 73 causes damage such as peeling of the AR coating, and therefore it is difficult to fix this damage.

Further, with the conventional optical fiber collimator 70 illustrated in FIG. 16, although the AR coating is preferably formed on the primary face 73a and the primary face 73b of the spacer 73, forming the AR coating is costly.

By contrast, according to embodiments of the present invention described below, it is possible to prevent a member for holding collimator lenses from being detached and prevent the AR coating from being damaged.

### First Embodiment

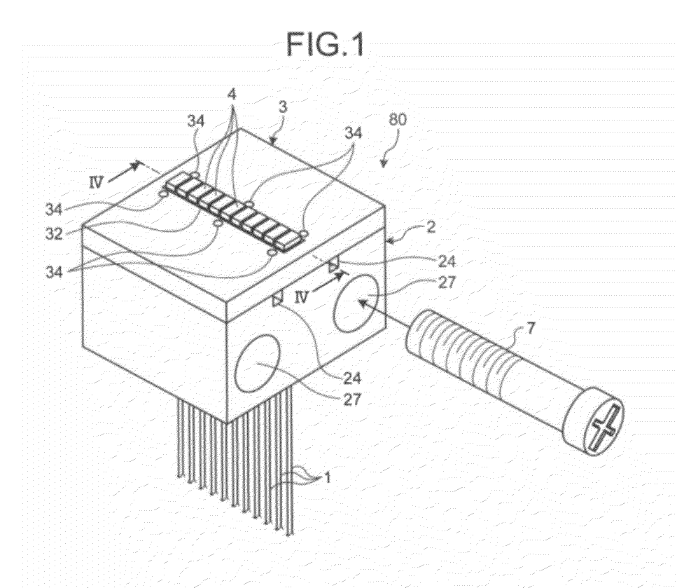

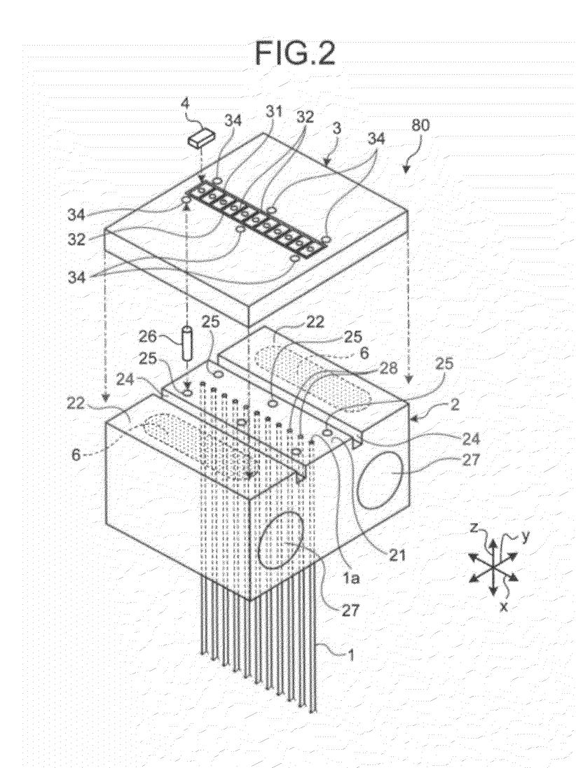

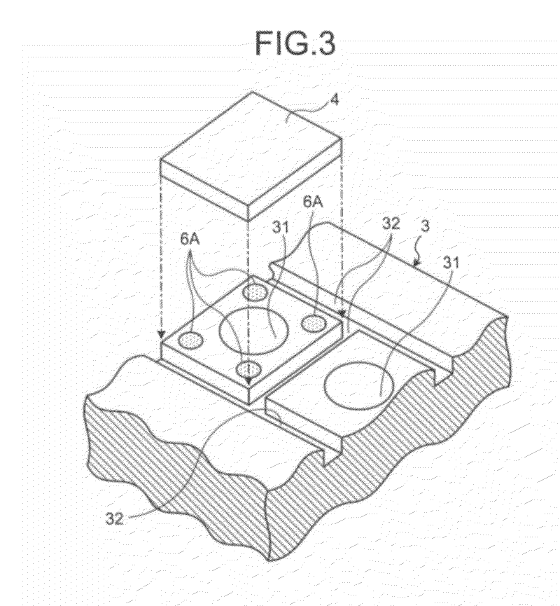

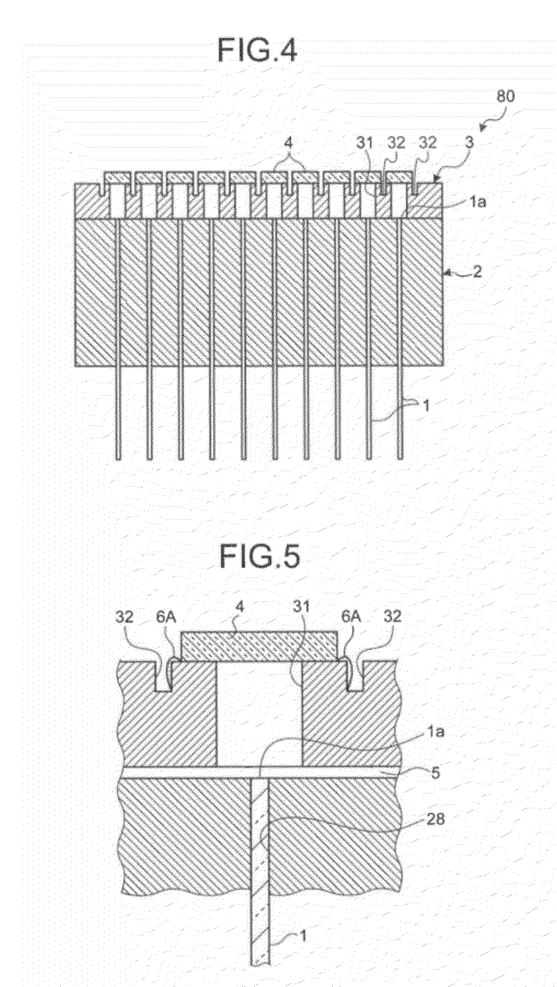

FIG. 1 is a schematic perspective view of an optical fiber collimator 80 which is an optical waveguide collimator according to the first embodiment, FIG. 2 is an exploded perspective view of the optical fiber collimator 80, FIG. 3 is an enlarged perspective view of a portion to which collimator lenses are attached, FIG. 4 is a sectional view of IV-IV in FIG. 1 and FIG. 5 is an enlarged sectional view of a portion to which the collimator lenses are attached.

As illustrated in FIG. 1, the optical fiber collimator 80 has a plurality of optical fibers 1 aligned in an array pattern, an optical fiber fixing base material 2 as an optical waveguide base material for fixing the optical fibers 1, a plurality of collimator lenses 4 arranged so as to correspond to the optical fibers 1, and a lens holding member 3 which holds collimator lenses 4.

The optical fiber fixing base material 2 is a member having a rectangular parallelepiped shape. The material of this optical fiber fixing base material 2 is not limited in particular, and may be made of, for example, glass, metal, ceramics or resin. Particularly, the optical fiber fixing base material 2 is preferably made of machinable ceramics because mechanical processing such as cutting work is easy, and the thermal expansion coefficient is, for example, about 9×10⁻⁶/° C. and is small to the same degree as the thermal expansion coefficient (about 7×10⁻⁶/° C.) of glass. The machinable ceramics is, for example, McCall (registered trademark). Further, for example, polyphenylene sulfide (PPS) or polycarbonate (PC) can be used as resin. As illustrated in FIG. 2, one end face (one end face in a z direction in FIG. 2) of the optical fiber fixing base material 2 has a light emitting face 21 on which optical fiber insertion holes 28 penetrating toward the other end face are formed. On one end face of the optical fiber fixing base material 2, a pair of adhering area faces 22 is formed on both ends of the light emitting face 21 in a y direction across partitioning grooves 24. That is, the pair of adhering area faces 22 sandwiches the light emitting face 21 across the partitioning grooves 24.

In the optical fiber fixing base material 2, the optical fibers 1 are fixed such that light emitting end faces 1a of the optical fibers 1 and the light emitting face 21 are coplanar with each other. That is, the light emitting face 21 and the light emitting end faces 1a are on the same plane. As illustrated in FIG. 5, on the light emitting face 21 including the light emitting end faces 1a, AR coating 5 formed of, for example, a multilayer dielectric film is formed.

Further, as illustrated in FIG. 2, in a peripheral part of the light emitting face 21 of the optical fiber fixing base material 2, a plurality of positioning holes 25 are formed. In these positioning holes 25, positioning pins 26 are inserted.

As illustrated in FIG. 1 and FIG. 2, in the optical fiber fixing base material 2, a pair of attachment through-holes 27 is formed along an x direction illustrated in FIG. 2 without interfering with the optical fiber insertion holes 28. As illustrated in FIG. 1, in these attachment through-holes 27, fixing screws 7 are inserted and screwed to attached portions (not illustrated) to fix the optical fiber fixing base material 2.

As illustrated in FIG. 2, adhesive 6 is applied on the adhering area faces 22 of the optical fiber fixing base material 2, and the adhering area faces 22 are adhered to corresponding areas of the lens holding member 3. In the lens holding member 3, positioning holes 34 are formed at positions corresponding to the positioning holes 25 of the optical fiber fixing base material 2. The positioning pins 26 are inserted in the positioning holes 34 to position the lens holding member 3.

As illustrated in FIGS. 2 to 4, in the lens holding member 3, a plurality of light passing holes 31 through which light from the light emitting end faces 1a of the optical fibers 1 passes are formed in positions corresponding to the optical fiber insertion holes 28 of the optical fiber fixing base material 2. On the surface of the lens holding member 3 opposite to the surface to which the optical fiber fixing base material 2 is bonded, adhesive accommodation grooves 32 formed to draw rectangular outlines outside the light passing holes 31 are formed. As illustrated in FIG. 2, the collimator lenses 4 are adhered in areas surrounded by the adhesive accommodation grooves 32. FIG. 3 is a perspective view showing that adhesive 6A is applied to four corners of the rectangular area surrounding the light passing hole 31 to bond with the collimator lens 4. The adhesive accommodation grooves 32 are formed to surround the light passing holes 31 in this way, so that, as illustrated in FIG. 5, a surplus of the adhesive 6A flows in the adhesive accommodation grooves 32, thereby preventing the adhesive 6A from flowing in areas to which the other collimator lenses 4 to be adhered. Consequently, it is possible to prevent the collimator lenses 4 from being contaminated and damaged, the adjacent collimator lenses 4 from being adhered and fixed to each other, and the collimator lenses 4 from inclining or floating due to the adhesive 6A. Particularly, according to the present embodiment, it is possible to prevent precision of the positions of the optical systems from decreasing due to inclination or floating of the collimator lenses 4.

Further, in recent years, an optical switch (wavelength selective switch) using an optical fiber collimator is demanded to decrease pitches for the collimator lens array. This is because, if the pitches of the collimator lens array are decreased, a switch angle of the optical switch is small, and the influence of the aberration of the lenses is small if light passes near the optical axis, and the optical switch is more easily miniaturized. According to the present embodiment, because the adhesive accommodation grooves 32 which accommodate the adhesive 6A are employed, it is possible to prevent the adhesive 6A from reaching the adhesive area of the adjacent collimator lens 4 and the collimator lenses 4 from floating or inclining when the adjacent collimator lens 4 is adhered. Consequently, it is possible to further narrow the pitches between the collimator lenses 4. FIG. 5 is a partial sectional view illustrating a state where the portion at which the collimator lens 4 is adhered is cut in the y direction illustrated in FIG. 2.

Although the rim parts of the adhesive accommodation groove 32 according to the present embodiment is a right angular shape in the cross section, chamfering the rim parts in sectional r shapes or tapered shapes allows the adhesive 6A to easily flow in the adhesive accommodation groove 32.

As illustrated in FIG. 4 and FIG. 5, the thickness of the lens holding member 3 secures the optimal interval distance between the collimator lenses 4 and light emitting end faces 1a of the optical fibers 1. This interval distance is set to, for example, about the focus distance of the collimator lens 4. In this case, light propagated through the optical fibers 1 is emitted from the light emitting end faces 1a, collimated by the collimator lenses 4, and emitted to the outside as parallel light.

The lens holding member 3 is adhered and fixed by the adhesive 6 applied to the adhering area faces 22 of the optical fiber fixing base material 2. However, the lens holding member 3 abuts on and is not adhered to the light emitting end faces 1a of the optical fiber fixing base material 2 on which the AR coating 5 is formed.

Thus, with this optical fiber collimator 80, the lens holding member 3 and the optical fiber fixing base material 2 are adhered to one another at the adhering area faces 22 which are the surfaces other than the light emitting face 21, and are not adhered but only abutted at the light emitting face 21 and the light emitting end faces 1a on which the AR coating 5 is formed. Further, when the AR coating is formed on the light emitting end faces 1a, the adhering area faces 22 are preferably masked so as not to be applied the AR coating. As a result, the lens holding member 3 does not cause damage by pulling the AR coating 5 due to an external force or inner stress and peeling off the AR coating 5. Further, the lens holding member 3 is not detached when the AR coating 5 is peeled off.

The material of the lens holding member 3 is not limited in particular, and may be made of, for example, glass, metal, ceramics or resin. Particularly, the lens holding member 3 is preferably made of machinable ceramics because mechanical processing such as cutting work is easy, and the thermal expansion coefficient is, for example, about 9×10⁻⁶/° C. and is small to the same degree as the thermal expansion coefficient (about 7×10⁻⁶/° C.) of glass. The machinable ceramics is, for example, McCall. Polyphenylene sulfide (PPS) or polycarbonate (PC) may be used as resin.

Further, particularly, the lens holding member 3 has the light passing holes 31 through which light from the light emitting end faces 1a of the optical fibers 1 passes. Consequently, the material of the lens holding member 3 may not be transparent, and the AR coating needs not to be formed on a surface on which the collimator lenses 4 are held.

As described above, with the optical fiber collimator 80 according to the first embodiment, the lens holding member 3 for the collimator lenses 4 is not easily detached. Further, it is possible to reduce the number of portions on which the AR coating 5 is provided and consequently reduce cost. Further, the AR coating 5 is not formed on the adherence surfaces, so that it is possible to improve reliability.

Another adhering means such as an adhesive sheet may be used instead of the adhesive 6.

### Second Embodiment

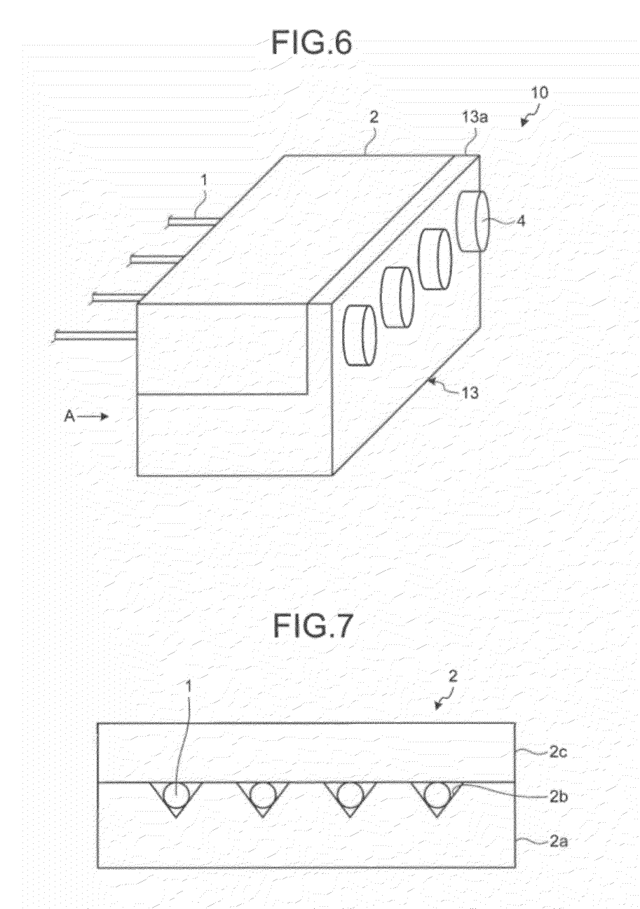

FIG. 6 is a schematic perspective view of an optical fiber collimator which is an optical waveguide collimator according to the second embodiment. As illustrated in FIG. 6, this optical fiber collimator 10 has a plurality of optical fibers 1 aligned in an array pattern, an optical fiber fixing base material 2 as an optical waveguide base material for fixing the optical fibers 1, a plurality of collimator lenses 4 arranged so as to correspond to the optical fibers 1, and a lens holding member 13 which holds collimator lenses 4 in a spacer portion 13a.

FIG. 7 is an A arrow view of the optical fiber fixing base material 2 of the optical fiber collimator 10 illustrated in FIG. 6. As illustrated in FIG. 7, the optical fiber fixing base material 2 has a base part 2a in which V grooves 2b are formed, and a lid part 2c which is fixed on the base part 2a. With this optical fiber fixing base material 2, the optical fibers 1 are set in the V grooves 2b, and are fixed in a state where the lid part 2c applies a minimal pressure to the optical fibers 1.

The material of this optical fiber fixing base material 2 is not limited in particular, and may be made of, for example, glass, metal or ceramics.

The optical fiber fixing base material 2 is not limited to the structure using the V grooves 2b illustrated in FIG. 7, and may adopt a structure in which through-holes are formed and the optical fibers 1 are inserted in these through-holes and fixed.

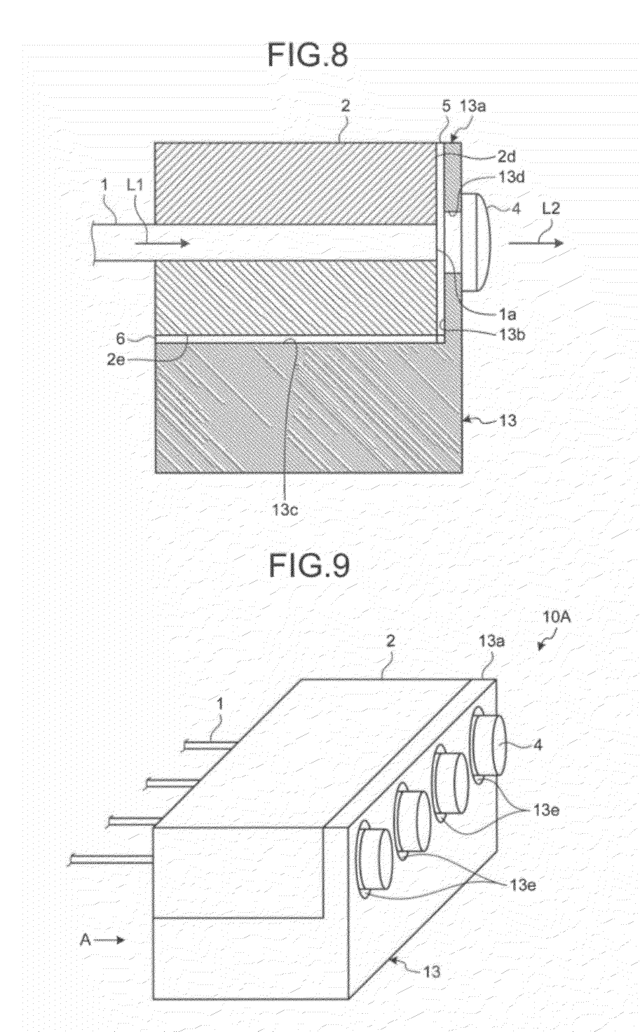

Next, FIG. 8 is a partial sectional view of the optical fiber collimator 10 illustrated in FIG. 6 along the optical fibers 1. As illustrated in FIG. 8, the optical fiber fixing base material 2 has the light emitting face 2d, and a lateral face 2e as an adhering area face and which is vertical to the light emitting face 2d. Further, in the optical fiber fixing base material 2, the optical fibers 1 are fixed such that the light emitting end faces 1a of the optical fibers 1 and the light emitting face 2d are coplanar with each other. That is, the light emitting face 2d and light emitting end faces 1a are on the same plane. Further, on the light emitting face 2d including the light emitting end faces 1a, the AR coating 5 formed with, for example, a multilayer dielectric film is formed.

Further, the lens holding member 13 has an L shape in its sectional shape, and has a lateral face 13b of the spacer portion 13a and a bonding face 13c as a bonding portion. Further, the spacer portion 13a has holes 13d. Further, the lens holding member 13 holds the collimator lenses 4 by way of bonding using, for example, adhesive. This lens holding member 13 secures an optimal interval distance between the collimator lenses 4 and the light emitting end faces 1a of the optical fibers 1 due to the thickness of the spacer portion 13a. This interval distance is set to, for example, about the focus distance of the collimator lens 4. In this case, light L1 propagated through the optical fibers 1 is emitted from the light emitting end faces 1a, collimated by the collimator lenses 4, and emitted to the outside as parallel light L2.

The lens holding member 13 is bonded and fixed to the lateral face 2e of the optical fiber fixing base material 2 by the adhesive 6 on the bonding face 13c. In contrast, the lateral face 13b of the spacer portion 13a abuts on and is not adhered to the light emitting face 2d of the optical fiber fixing base material 2 on which the AR coating 5 is formed.

Thus, with this optical fiber collimator 10, the lens holding member 13 and the optical fiber fixing base material 2 are adhered at the lateral face 2e which is the surface other than the light emitting face 2d, and are not adhered but only abutted at the light emitting end faces 1a and light emitting face 2d on which the AR coating 5 is formed. As a result, the lens holding member 13 does not cause damage by pulling the AR coating 5 due to an external force or inner stress and peeling off the AR coating 5. Further, the lens holding member 13 is not detached when the AR coating 5 is peeled off.

The material of the lens holding member 13 is not limited in particular, and may be made of, for example, glass, metal or ceramics. Particularly, the lens holding member 13 is preferably made of machinable ceramics because mechanical processing such as cutting work is easy, and the thermal expansion coefficient is, for example, about 9×10⁻⁶/° C. and is small to the same degree as the thermal expansion coefficient (about 7×10⁻⁶/° C.) of glass. The machinable ceramics is, for example, McCall.

Further, particularly, the lens holding member 13 has the holes 13d through which light from the light emitting end faces 1a of the optical fibers 1 passes in the spacer portion 13a as illustrated in FIG. 8. Consequently, the material of the lens holding member 13 may not be transparent, and the AR coating needs not to be formed on the lateral face of the spacer portion 13a which holds the collimator lenses 4.

As described above, with the optical fiber collimator 10 according to the second embodiment, the lens holding member 13 for the collimator lenses 4 is not easily detached. Further, the AR coating needs not to be formed on the lateral face 13b of the spacer portion 13a.

In the above embodiment, another bonding means such as an adhesive sheet may be used instead of the adhesive 6.

### Modified Example of Second Embodiment

FIG. 9 is a perspective view illustrating an optical fiber collimator 10A according to a modified example of the above second embodiment. The modified example differs from the above second embodiment only in forming adhesive accommodation grooves 13e around areas (circular areas) where the collimator lenses 4 are bonded in the spacer portion 13a of the lens holding member 13, and the other configurations are the same as the optical fiber collimator 10 according to the second embodiment. Although, in the modified example, the adhesive accommodation grooves 13e are preferably formed right outside and along an outline of the areas where the collimator lenses 4 are bonded, the distance between the outline and adhesive accommodation grooves needs not to be constant at all time.

According to this modified example, because a surplus of the adhesive to which the collimator lenses 4 are adhered flows in the adhesive accommodation grooves 13e, it is possible to prevent the collimator lenses 4 from being contaminated and damaged. Consequently, by providing the adhesive accommodation grooves 13e between the collimator lenses 4, intervals between the collimator lenses 4 need not to be large, thereby further narrowing the pitches between the collimator lenses 4. Further, it is possible to prevent the adjacent collimator lenses 4 from being adhered and fixed to each other, and prevent precision of the positions of the optical systems from decreasing because the adhesive attaches to the areas to which the adjacent collimator lenses 4 are adhered and therefore the collimator lenses 4 incline or float.

### Third Embodiment

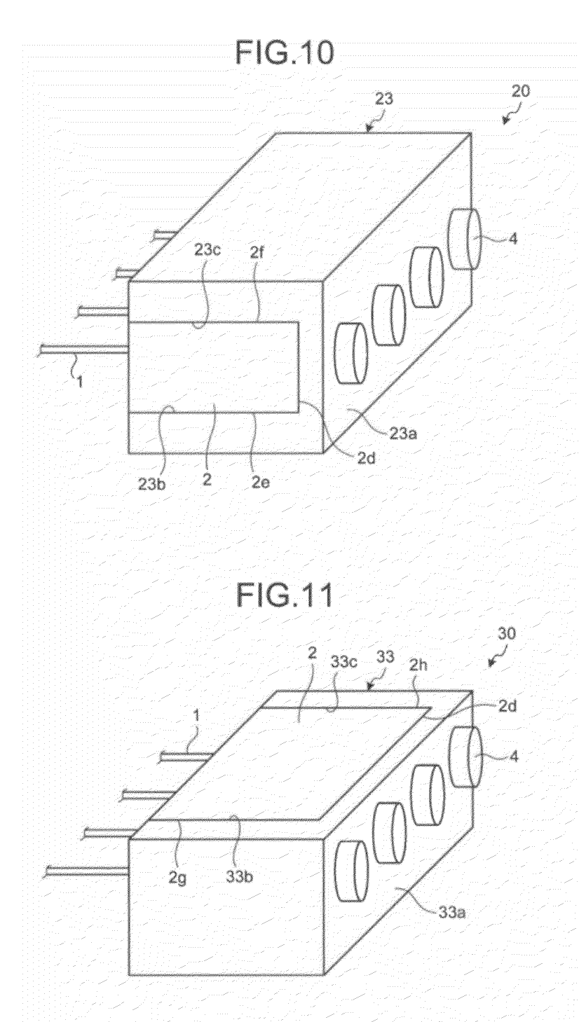

Next, the third embodiment of the present invention will be described. FIG. 10 is a schematic perspective view of an optical fiber collimator according to the third embodiment. As illustrated in FIG. 10, the optical fiber collimator 20 is provided by replacing the lens holding member 13 of the optical fiber collimator 10 illustrated in FIG. 6 with a lens holding member 23 having a U-shaped sectional surface.

In this lens holding member 23, bonding faces 23b and 23c are bonded to lateral faces 2e and 2f of the optical fiber fixing base material 2 by adhesive, and a spacer portion 23a is not bonded to the light emitting face 2d of the optical fiber fixing base material 2. Hence, with this configuration, the lens holding member 23 is not easily detached.

### Fourth Embodiment

Next, the fourth embodiment of the present invention will be described. FIG. 11 is a schematic perspective view of an optical fiber collimator 30 according to the fourth embodiment. As illustrated in FIG. 11, the optical fiber collimator 30 is provided by replacing the lens holding member 13 of the optical fiber collimator 10 illustrated in FIG. 6 with a lens holding member 33 having a U-shaped sectional surface.

The lens holding member 33 is the same as the lens holding member 23 illustrated in FIG. 10 in terms of the U-shaped sectional surface. However, in this lens holding member 33, bonding faces 33b and 33c are adhered to other lateral faces 2g and 2h of the optical fiber fixing base material 2 by adhesive, and a spacer portion 33a is not adhered to the light emitting faces 2d of the optical fiber fixing base material 2. With the configuration of the optical fiber collimator 30, the lens holding member 33 is not easily detached.

### Fifth Embodiment

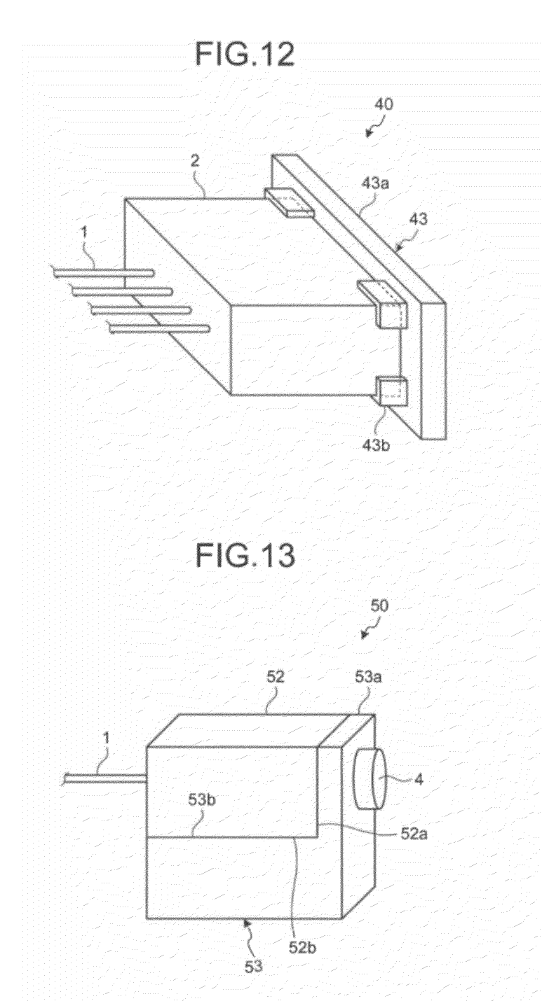

Next, the fifth embodiment of the present invention will be described. FIG. 12 is a schematic perspective view of an optical fiber collimator according to the fifth embodiment. As illustrated in FIG. 12, the optical fiber collimator 40 is provided by replacing the lens holding member 13 of the optical fiber collimator 10 illustrated in FIG. 6 with a lens holding member 43.

This lens holding member 43 has four U-shaped fitting members 43b as bonding portions which project from a spacer portion 43a holding collimator lenses (not illustrated). Further, the lens holding member 43 is adhered to the optical fiber fixing base material 2 by adhesive applied to the fitting members 43b in a state where the optical fiber fixing base material 2 is fitted in a frame formed by these fitting members 43b. With the configuration of the optical fiber collimator 40, the lens holding member 43 is not easily detached.

### Sixth Embodiment

Although the optical fibers 1 are aligned in an array pattern with the above embodiments, the number of optical fibers 1 is not limited. With the sixth embodiment of the present invention described below, the number of optical fiber is one.

FIG. 13 is a schematic perspective view of an optical fiber collimator according to the sixth embodiment. As illustrated in FIG. 13, the optical fiber collimator 50 has one optical fiber 1, an optical fiber fixing base material 52 which fixes the optical fiber 1, one collimator lens 4 arranged so as to correspond to the optical fiber 1, and a lens holding member 53 which holds the collimator lens 4 in a spacer portion 53a.

In the lens holding member 53, a lateral face 52b of the optical fiber fixing base material 52 is adhered to a bonding face 53b by adhesive, and the spacer portion 53a is not adhered to a light emitting face 52a of the optical fiber fixing base material 52. With the configuration of the optical fiber collimator 50, the lens holding member 53 is not easily detached.

In the above third to sixth embodiments, the materials of the optical fiber fixing base material and lens holding member are the same as those in the above first embodiment and second embodiment.

### Seventh Embodiment

Next, an optical switching device according to the seventh embodiment of the present invention will be described. The optical switching device according to the seventh embodiment is a wavelength selective optical switching device which selects an optical signal with a predetermined wavelength from an input wavelength multiplexing optical signal, switches from one path to another depending on the wavelength of the selected optical signal and outputs the optical signal.

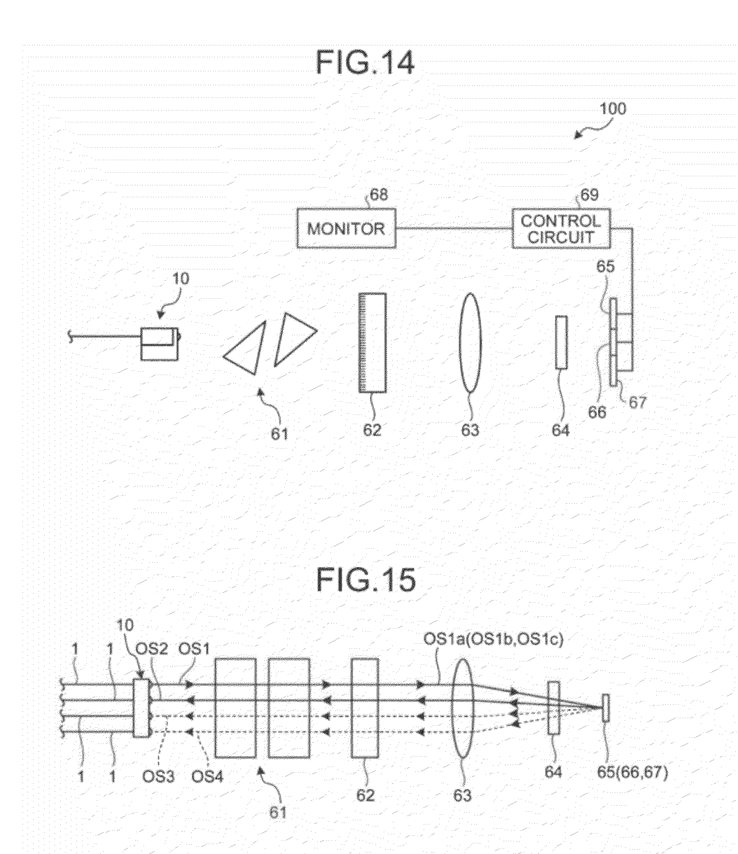

FIG. 14 is a block diagram illustrating a configuration of an optical switching device 100 according to the seventh embodiment. As illustrated in FIG. 14, the optical switching device 100 has the optical fiber collimator 10 according to the second embodiment illustrated in FIG. 6 in which optical fibers are respectively connected to different optical fiber transmission paths, and has an anamorphic prism pair 61, a diffraction grating 62, a condenser lens 63, a λ/4 wave plate 64, and three movable mirrors 65 to 67 which are, for example, MEMS (Micro Electro Mechanical Systems) mirrors arranged in an array pattern, all of which are sequentially arranged with respect to the optical fiber collimator 10. Further, the optical switching device 100 has a monitor element 68 and a control circuit 69 for controlling the three movable mirrors 65 to 67. Although an optical path is actually bent by the diffraction grating 62 and therefore each element from the anamorphic prism pair 61 to the movable mirrors 65 to 67 is arranged so as to form an angle before and after the diffraction grating 62, FIG. 14 illustrates arrangement in series for ease of description.

Next, the operation of the optical switching device 100 will be described. FIG. 15 is an explanatory diagram of the operation of the optical switching device 100 illustrated in FIG. 14. In addition, FIG. 15 illustrates the optical switching device 100 viewed from a direction (from above) perpendicular to the direction in FIG. 14. First, the optical fiber collimator 10 outputs a wavelength multiplexing optical signal OS1, which has been transmitted through an optical fiber transmission path and is inputted from the optical fiber 1, to the anamorphic prism pair 61 as parallel light. The anamorphic prism pair 61 expands the beam diameter of the wavelength multiplexing optical signal OS1 in an alignment direction of a grating of the diffraction grating 62, and the wavelength multiplexing optical signal OS1 strikes on as much grating as possible to improve the resolution of selecting the wavelength. The diffraction grating 62 outputs an optical signal OS1a with a predetermined wavelength included in the inputted wavelength multiplexing optical signal OS1 at a predetermined angle. The condenser lens 63 condenses the optical signal OS1a on the movable mirror 65 through the λ/4 wave plate 64.

The movable mirror 65 reflects the condensed optical signal OS1a on a surface of the mirror. The reflected light sequentially passes through the λ/4 wave plate 64, the condenser lens 63, the diffraction grating 62 and the anamorphic prism pair 61 as a reflected optical signal OS2, is inputted in a desired optical fiber 1 of the optical fiber collimator 10, and is outputted to the optical fiber transmission path connected to the optical fiber 1. The λ/4 wave plate 64 changes light polarized states of the optical signal OS1a and reflected optical signal OS2 such that the polarized states are orthogonal to each other. By this means, polarized wave dependency of the anamorphic prism pair 61 and the diffraction grating 62 is compensated.

The diffraction grating 62 outputs optical signals OS1b and OS1c of other predetermined wavelengths included in the wavelength multiplexing optical signal OS1 at other predetermined angles. The optical signals OS1b and OS1c are reflected by the movable mirrors 66 and 67 respectively, sequentially pass through the λ/4 wave plate 64, condenser lens 63, diffraction grating 62 and anamorphic prism pair 61 as a reflected optical signal OS3 and reflected optical signal OS4, are respectively inputted in desired optical fibers 1 of the optical fiber collimator 10, and are outputted to the optical fiber transmission paths connected to these optical fibers 1.

The movable mirrors 65 to 67 are controlled such that the monitor element 68 monitors the wavelength and intensity of light branched from part of the reflected optical signals OS2 to OS4, and each mirror part of the movable mirrors 65 to 67 independently moves based on this monitoring result, so that reflection angles of the reflected optical signals OS2 to OS4 become optimal. It is possible to branch the reflected optical signals OS2 to OS4 by, for example, providing a branching coupler in part of the optical fiber collimator 10 or providing a branching mirror at an adequate position in the optical switching device 100. The monitor element 68 includes, for example, an AWG (Arrayed Waveguide Grating) element and a plurality of photo diodes.

The optical switching device 100 has the optical fiber collimator 10 according to the second embodiment, which allows the optical switching device 100 easily to be restored to the original state.

Although the optical fiber is employed as the optical waveguide in the above embodiments, the optical waveguide base material may be PLC (Planar Lightwave Circuit), and the optical waveguide may be formed on the PLC.

The present invention is not limited to the above embodiments. The present invention also includes a configuration adequately combining each element of each of the embodiments. For example, the optical fiber collimator according to the first embodiment, modified example of the second embodiment, or third to sixth embodiment may be employed in the optical switching device according to the seventh embodiment.

Further, in the optical fiber collimators according to the above third to sixth embodiments, the same adhesive accommodation grooves as the adhesive accommodation grooves 13e formed in the modified example of the above second embodiment may be formed around arrangement areas of the collimator lenses.

As described above, the optical waveguide collimator and optical switching device according to the present invention are suitable for use in the field of large-capacity optical fiber transmission.

According to the embodiments, it is possible to prevent a member for holding collimator lenses from being detached.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical waveguide collimator comprising:
an optical waveguide base material which includes a light emitting face having a light emitting end face of an optical waveguide, and an adhering area face provided separated from the light emitting face;
a collimator lens arranged on a light emitting end face side of the optical waveguide; and
a lens holding member which holds the collimator lens and which is adhered and fixed to the adhering area face of the optical waveguide base material.

2. The optical waveguide collimator according to claim 1, wherein
the lens holding member comprises:
a spacer portion which maintains a predetermined distance between the light emitting end face and the collimator lens; and
a bonding portion which is adhered and fixed to the adhering area face.

3. The optical waveguide collimator according to claim 1, wherein:
the optical waveguide is an optical fiber; and
the optical waveguide base material is formed such that the light emitting face of the optical waveguide base material and the light emitting end face of the optical fiber are coplanar with each other.

4. The optical waveguide collimator according to claim 1, wherein
the lens holding member comprises a hole through which light from the light emitting end face of the optical waveguide passes.

5. The optical waveguide collimator according to claim 1, wherein
the lens holding member is made of glass, machinable ceramics or resin.

6. The optical waveguide collimator according to claim 1, wherein
an anti-reflection film is formed on the light emitting end face of the optical waveguide.

7. The optical waveguide collimator according to claim 6, wherein
the anti-reflection film is formed on the light emitting face of the optical waveguide base material including the light emitting end face of the optical waveguide.

8. The optical waveguide collimator according to claim 1, comprising:
a plurality of optical waveguides arranged in an array pattern; and
a plurality of collimator lenses arranged so as to correspond to the optical waveguides.

9. The optical waveguide collimator according to claim 1, wherein:
the collimator lens is adhered to the lens holding member by adhesive; and
an adhesive accommodation groove is formed in the lens holding member around an area on which the collimator lens is arranged.

10. An optical switching device comprising the optical waveguide collimator according to claim 1.
